(19) United States
(12) Patent Application Publication
(10) Pub. No.: US 2008/0128535 A1
(43) Pub. Date: Jun. 5, 2008

(54) Fuel injection valve

(75) Inventors: Masayuki Aota, Tokyo (JP); Toshiya Chazono, Tokyo (JP); Yutaka Ikura, Tokyo (JP); Akio Shingu, Tokyo (JP); Kouichi Ojima, Tokyo (JP); Manabu Hirai, Hyogo (JP); Tsuyoshi Munezane, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, Chiyoda-ku (JP)

(21) Appl. No.: 11/797,118

(22) Filed: May 1, 2007

(30) Foreign Application Priority Data
Nov. 30, 2006 (JP) 2006-323159

(51) Int. Cl. F02M 61/04

(52) U.S. Cl. 239/533.12

(57) ABSTRACT

A fuel injection valve includes a valve seat which has a valve seat surface, an injection nozzle having an inclined axis center, and a conically-shaped tapered surface located between the valve seat surface and the injection nozzle; and a valve element for controlling fuel supply to the injection nozzle. One part of an opening of the injection nozzle is connected to the tapered surface; the other part of the opening is connected to the valve seat surface; and a relationship between an angle θ1 formed by the injection nozzle and the tapered surface at an area where the injection nozzle is connected to the tapered surface side, and an angle θ2 formed by the injection nozzle and the valve seat surface at an area where the injection nozzle is connected to the valve seat surface side is configured to be θ1≧θ2.

### BACKGROUND OF THE INVENTION

1. Field of the Invention

The present invention relates to a fuel injection valve which is for supplying fuel to a combustion chamber of an internal combustion engine for a car engine and the like.

2. Description of the Related Art

For example, in a fuel injection valve which directly injects fuel into a cylinder, there is a case where an injection nozzle is inclined to the axis center of the fuel injection valve because of layout limitations of the fuel injection valve, or in order to effectively use a swirling energy for fuel atomization by giving the swirling energy to the fuel.

In such a structure, since the injection nozzle is inclined to the axis center, an inflow angle of the fuel in flowing from upstream of the injection nozzle into the injection nozzle is different in a circumferential direction; and therefore, flow resistance due to bend loss in a flow of fuel on the side of a large angular variation becomes larger than that in a flow of fuel on the side of a small angular variation. Consequently, fuel flow volume on the side of the large angular variation is smaller than that of the small angular variation. This makes fuel spray nonuniform spray in the circumferential direction, and such nonuniformity of the fuel spray becomes a factor that makes mixture characteristics of air and fuel in the engine cylinder degrade, and eventually becomes one of deteriorating factors of exhaust gas of the engine.

In view of the foregoing, heretofore, there have been proposed fuel injection valves disclosed in, for example, Japanese Unexamined Patent Publication No. 2002-364497 (referred to as patent document 1 below), Japanese Unexamined Patent Publication No. 2000-303934 (referred to as patent document 2 below), and Japanese Domestic Re-Publication of PCT International Publication for Patent Application No. WO2004/070200 (referred to as patent document 3 below), as those which reduce fuel flow velocity difference and flow velocity degradation in the inclined injection nozzle and suppress generating stagnation in the flow of fuel.

FIG. 3 and FIG. 4 are a partially enlarged view adjacent to a valve seat and a view typically showing a flow of fuel in the valve seat of the hitherto known fuel injection valve disclosed in the patent document 1.

In FIG. 3 and FIG. 4, a valve body has a structure assembled by respective components of a valve element 31, a needle valve 7, a swirler 8, and a valve seat 9 having an injection nozzle 93; and the swirler 8 gives a swirling energy to fuel supplied from a fuel supply pipe (not shown) and supplies the same to the injection nozzle 93 of the valve seat 9. As shown in FIG. 4, in the inside of the valve seat 9, the fuel given with the swirling energy by the swirler 8 flows along internal wall surfaces of a valve seat surface 91, a tapered surface 92, and the injection nozzle 93 to a downstream side while swirling, and is injected froman injection nozzle outlet.

The injection nozzle 93 has a structure inclined to the center axis of the fuel injection valve; a flow of fuel does not become axial symmetry due to the inclination of the injection nozzle 93; and consequently, spray becomes asymmetry (unevenness). On the other hand, in the fuel injection valve disclosed in the patent document 1, the length of the injection nozzle 93 is formed to be substantially even over the whole inner circumference surface; and accordingly, the fuel injection valve is aimed that a film thickness in the injection nozzle is to be substantially symmetric and spray distribution is uniformized.

However, in the patent document 1, specific considerations are not made at all about suppression against the case where the flow of fuel in flowing in to the injection nozzle 93 becomes ununiform due to asymmetry in the bend loss. (The detail will be described later.)

In addition, in the patent document 2, in a structure where the injection nozzle inclined to the center axis of the fuel injection valve is opened in a fuel injection chamber formed in a spherical concave surface, there is disclosed a structure which aims to reduce flow velocity degradation due to the bend loss on the inner angle side and to uniformize atomization shape by forming chamfering at an injection nozzle inlet, and by making the amount of chamfering on the inner angle side larger than the amount of chamfering on the outer angle side.

Further, in the patent document 3, in the fuel injection valve having the inclined injection nozzle, there is disclosed a structure which aims to suppress generating the stagnation in the flow of fuel by providing a cylindrical intermediate flow path having a cylindrical surface coaxial with a conical flow path between the conical flow path and the injection nozzle, and by connecting the injection nozzle to a conical surface of a valve seat surface and the cylindrical surface of the intermediate flow path.

In the patent document 1, as one of causes for generating unevenness in the flow of fuel due to the inclination of the injection nozzle, there is a case where the bend loss of the flow of fuel in flowing into the injection nozzle becomes nonuniform in a circumferential direction (the right and left in the drawing). This will be described using FIG. 4.

The fuel flowing in the valve seat 9 flows by the swirling energy given by the swirler 8 along the internal wall surfaces in the inside of the valve seat surface 91, the tapered surface 92, and the injection nozzle 93. This flow of fuel is shown by C1 and C2. The flow of fuel C1 and C2 generate velocity degradation (degradation of flow volume) due to the bend loss according to angular variations of the flow at continuation portions A1 and A2 of the valve seat surface 91 and the tapered surface 92, and at continuation portions B1 and B2 of the tapered surface 92 and the injection nozzle 93. At this time, the injection nozzle 93 inclines, and accordingly the bend loss in flowing from the tapered surface 92 to the injection nozzle 93 differs between the left side (B1) shown in FIG. 4 and the right side (B2) shown in FIG. 4, thereby generating the unevenness of the flow in the circumferential direction. This is inevitably generated due to the inclination of the injection nozzle 93; however, countermeasures against such case are not disclosed for the fuel injection valve disclosed in the patent document 1, and therefore suppression against spray unevenness is not sufficient.

In addition, in the patent document 2, since chamfering work is made at the inlet of the injection nozzle inclined to the axis center of the fuel injection valve, the chamfering work is also made at an axis inclined to the axis of the fuel injection valve. Therefore, even if the amount of chamfering is uniform in a circumferential direction, workability is bad. Additionally, since the different amount of chamfering is made at the inner angle side and the outer angle side, the chamfering work becomes a work at an axis having offset also to the axis of the injection nozzle; and consequently, the workability becomes worse.

Further, positioning with the injection nozzle is required in the chamfering work.

As described above, in the patent document 2, there is a problem from a view point of workability of the chamfering work.

In addition, in the patent document 3, the intermediate flow path between the valve seat surface and the injection nozzle is formed in the cylindrical surface. Therefore, it is difficult to have a relationship between an angle θ1 formed by the injection nozzle and the tapered surface at an area where the injection nozzle is opened on the side of the tapered surface, and an angle θ2 formed by the injection nozzle and the valve seat surface at an area where the injection nozzle is opened in the valve seat surface, to be an angle configuration of θ1>θ2.

That is, usually, an inclined angle of the injection nozzle in the fuel injection valve is determined by request specifications (request specifications on the engine side) of a fuel spray direction. In addition, a taper angle of the valve seat surface is also determined in consideration of a flow path area of the valve seat, durability, and the like. Consequently, there is basically no degree of freedom in setting the both angles. Therefore, there is basically no degree of freedom in the angle θ2 formed by the valve seat surface and the injection nozzle. Further, since the intermediate flow path disclosed in the patent document 3 is formed on the cylindrical surface, there is no degree of freedom also in the angle θ1 formed by the intermediate flow path and the injection nozzle.

For this reason, it is difficult to have the angle configuration of θ1>θ2 in the fuel injection valve disclosed in the patent document 3.

### BRIEF SUMMARY OF THE INVENTION

An object of the present invention is to solve the foregoing problems of the hitherto known apparatuses, and to provide a fuel injection valve which can secure fuel spray uniformity with a simple and inexpensive configuration even in a structure in which an injection nozzle is inclined to the axis center of the fuel injection valve.

According to the present invention, there is provided a fuel injection valve which includes a valve seat having a valve seat surface for forming a conical flow path along a flow direction of fuel, an injection nozzle communicated at a downstream side of the conical flow path and having an axis center inclined to an axis center of the conical flow path, and a conically-shaped tapered surface located between the valve seat surface and the injection nozzle; a valve element disjunct from the valve seat surface at a contact portion, for controlling fuel supply to the injection nozzle; and an actuator for actuating the valve element. One part of an opening on a fuel introducing side of the injection nozzle is connected to the tapered surface, and the other part of the opening on the fuel introducing side of the injection nozzle is connected to the valve seat surface. A relationship between an angle θ1 formed by the injection nozzle and the tapered surface at an area where the injection nozzle is connected to the tapered surface side, and an angle θ2 formed by the injection nozzle and the valve seat surface at an area where the injection nozzle is connected to the valve seat surface side is configured to be θ1≧θ2.

According to a fuel injection valve of the present invention, fuel spray uniformity can be improved with a simple structure even if an injection nozzle has a structure in which the injection nozzle is inclined to the axis center of the fuel injection valve.

In addition, there can be obtained a fuel injection valve which can be manufactured with easy workability and at low cost.

The foregoing and other object, features, and advantages of the present invention will become more apparent from the following detailed description of a preferred embodiment and description shown in drawings.

### BRIEF DESCRIPTION OF THE SEVERAL VIEWS OF THE DRAWINGS

FIG. 1 is a schematic sectional configuration view showing a whole configuration of a fuel injection valve in a preferred embodiment 1 according to the present invention;

FIG. 2 is a partially enlarged view adjacent to a valve seat for explaining a flow of fuel in an injection nozzle in the preferred embodiment 1 according to the present invention;

FIG. 3 is a partially enlarged view adjacent to a valve seat showing an example of a hitherto known fuel injection valve; and

FIG. 4 is a view typically showing a flow of fuel in the valve seat shown in FIG. 3.

### DETAILED DESCRIPTION OF THE INVENTION

### Preferred Embodiment 1

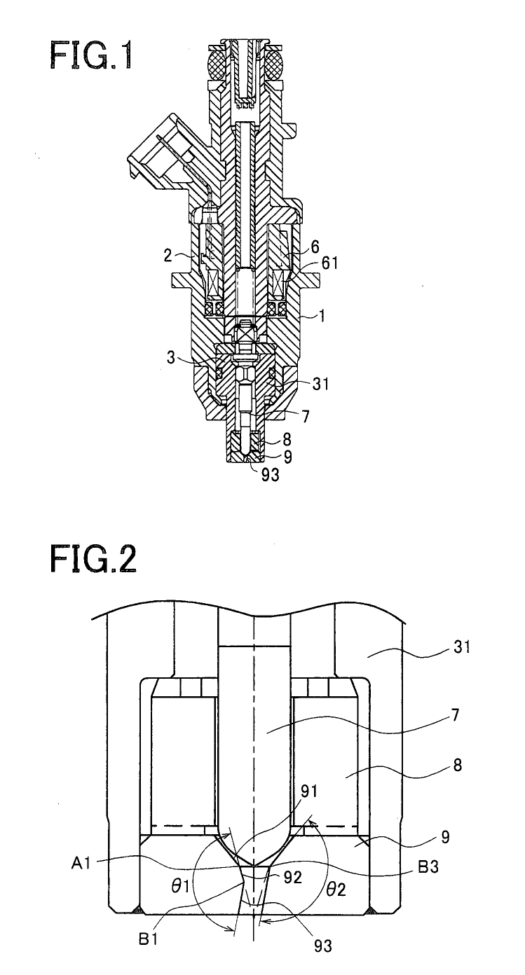

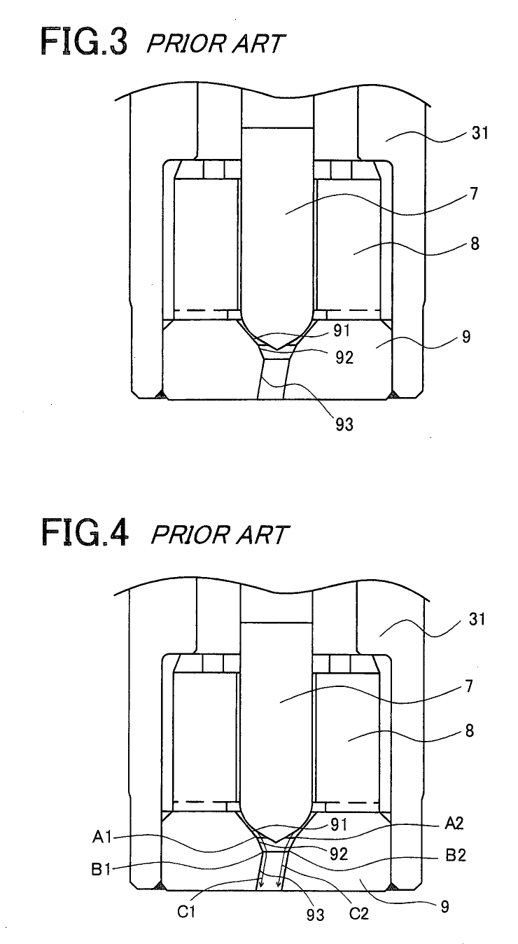

A fuel injection valve of a preferred embodiment 1 according to the present invention will be described below with reference to FIG. 1 and FIG. 2.

FIG. 1 is a sectional configuration view showing a whole configuration of the fuel injection valve of the preferred embodiment 1. FIG. 2 is a partially enlarged view adjacent to a valve seat shown in FIG. 1, and explains a flow of fuel in an injection nozzle. In addition, the same reference numerals represent the same or corresponding elements throughout the respective drawings.

In FIG. 1, a fuel injection valve 1 includes an external housing 2, a valve body 3, and a valve actuator 6 for actuating a needle valve 7 (to be described later) by an electromagnetic coil 61.

In addition, the valve body 3 has a structure assembled by respective components of a valve element 31, the needle valve 7, a swirler 8, and a valve seat 9 having an injection nozzle 93; and the swirler 8 functions to give a swirling energy to fuel supplied from a fuel supply pipe (not shown) and supplies the same to the injection nozzle 93 of the valve seat 9.

As shown in FIG. 2, the valve seat 9 is formed with a valve seat surface 91 where the needle valve 7 is mounted to secure valve sealing performance, the injection nozzle 93 which is for injecting fuel, and a conically-shaped tapered surface 92 disposed between the valve seat surface 91 and the injection nozzle 93. In this case, the injection nozzle 93 inclines to the axis center of the fuel injection valve 1.

The injection nozzle 93 has one part of an opening on the fuel-introducing side (the left side shown in FIG. 2) which is opened in the tapered surface 92, and the other part of the opening on the fuel-introducing side (the right side shown in FIG. 2) which is opened in the valve seat surface 91.

Therefore, under ordinary circumstances, the tapered surface 92 is cut away by the injection nozzle 93 on the right side shown in FIG. 2; however, for the sake of explanation, the tapered surface is also designated by a dashed line on the right side shown in FIG. 2. In addition, the tapered surface 92 is in a conical shape whose center axis is the axis center of the fuel injection valve 1.

The fuel given with the swirling force by the swirler 8 flows along the internal wall surface of the valve seat 9 in the order of the valve seat surface 91, the tapered surface 92, and the injection nozzle 93; and then, the fuel is injected from the injection nozzle outlet. At this time, bend loss is generated due to bending of the flow of fuel at areas A1, B1, and B3 where an angle of the flow of fuel varies; and accordingly, flow velocity is reduced.

Unevenness in the flow of fuel due to the inclination of the injection nozzle 93 is caused because the injection nozzle 93 is inclined, and thus a fuel inflow angle at the injection nozzle inlet differs in a circumferential direction; and accordingly, the bend loss in the circumferential direction differs, and generates a difference in a flow velocity (flow volume). However, in the preferred embodiment 1, the tapered surface 92 is configured at only the left side shown in FIG. 2 between the valve seat surface 91 and the injection nozzle 93; and accordingly, the bend loss in the flow on the left side, which was large formerly, can be reduced. In this case, a bending angle that determines the bend loss in flowing into the injection nozzle 93 is designated as an angle θ1 at the left side shown in FIG. 2, and an angle θ2 at the right side shown in FIG. 2; and the angles θ1 and θ2 are set to θ1>θ2 in the preferred embodiment 1.

As described above, in the preferred embodiment 1 according to the present invention, the conically-shaped tapered surface 92 is configured at upstream of the injection nozzle 93 as an intermediate flow path; and the injection nozzle 93 is configured to have one part of the opening on the fuel-introducing side (the left side shown in FIG. 2) which is opened in the tapered surface 92, and the other part of the opening on the fuel-introducing side (the right side shown in FIG. 2) which is opened in the valve seat surface 91. This reduces the bend loss in the flow on the left side shown in FIG. 2 by the tapered surface 92; and therefore, nonuniformity of the fuel spray due to the inclination of the injection nozzle 93 can be reduced.

In this case, the bend loss in flowing the fuel into the injection nozzle 93 is determined by the angle 91 formed by the injection nozzle 93 and the tapered surface 92 on the left side shown in FIG. 2; on the right side shown in FIG. 2, the bend loss is determined by the angle θ2 formed by the injection nozzle 93 and the seat surface 91; and therefore, a relationship of θ1=θ2 is desirable in order to equalize the flow loss in flowing into the injection nozzle 93 between the left side and the right side shown in drawing.

However, the flow on the left side shown in FIG. 2 comes under the influence of the flow loss in some degree due to the angular difference between the valve seat surface 91 and the tapered surface 92; and therefore, it may be considered that the flow velocity in the left side flow is slightly reduced as compared with that in the right side flow at the injection nozzle inlet. Consequently, in consideration of the influence, the relationship between θ1 and θ2 is set to θ1>θ2, and the bend loss at the injection nozzle inlet is set so that the bend loss on the left side is smaller than the bend loss on the right side; thereby enabling to uniformize the flow in the injection nozzle.

In addition, a degree of influence to the flow velocity at the injection nozzle inlet due to the flow loss generated by the angular difference between the valve seat surface 91 and the tapered surface 92 varies according to the size of the angular difference between the valve seat surface 91 and the tapered surface 92, the length of the tapered surface 92, and the like; and therefore, the angular difference between θ1 and θ2 may be arbitrarily designed. In this case, in the preferred embodiment 1, since the intermediate flow path between the valve seat surface 91 and the injection nozzle 93 is formed in the conically-shaped tapered surface, the angular difference between θ1 and θ2 can be easily and discretionarily set.

In addition, in the case where the degree of influence of the flow loss generated by the angular difference between the valve seat surface 91 and the tapered surface 92 is small, and a degree of influence on spray performance of the fuel injection valve is very small, there is no problem even if the relationship between θ1 and θ2 is set to θ1=θ2.

Further, the conically-shaped tapered surface 92 is arranged coaxially with the fuel injection valve 1; and accordingly, machining can be easily performed with usual cutting work, grinding work, and the like. In addition, circumferential positioning of the tapered surface 92 and the opening of the injection nozzle is not required because of the coaxial arrangement with the fuel injection valve 1. This makes it possible to manufacture the fuel injection valve with easy workability and at low cost.

Various modifications and alternations of this invention will be apparent to those skilled in the art without departing from the scope and spirit of this invention, and it should be understood that this is not limited to the illustrative embodiments set forth herein.

What is claimed is:

1. A fuel injection valve comprising:
a valve seat having a valve seat surface for forming a conical flow path along a flow direction of fuel, an injection nozzle communicated at a downstream side of the conical flow path and having an axis center inclined to an axis center of the conical flow path, and a conically-shaped tapered surface located between the valve seat surface and the injection nozzle;
a valve element disjunct from the valve seat surface at a contact portion, for controlling fuel supply to the injection nozzle; and
an actuator for actuating the valve element;
the injection nozzle having one part of an opening on a fuel introducing side, connected to the tapered surface, and
the other part of the opening on the fuel introducing side, connected to the valve seat surface;
the injection nozzle being formed with
an angle θ1 formed by the injection nozzle and the tapered surface at an area where the injection nozzle is connected to the tapered surface side, and
an angle θ2 formed by the injection nozzle and the valve seat surface at an area where the injection nozzle is connected to the valve seat surface side; and
the angle θ1 and the angle θ2 being configured to have a relationship of θ1≧θ2.

2. The fuel injection valve according to claim 1, wherein the conically-shaped tapered surface located between the injection nozzle and the valve seat surface is arranged on an axis center of the valve element.
